(19) United States
(12) Patent Application Publication
(10) Pub. No.: US 2024/0051130 A1
(43) Pub. Date: Feb. 15, 2024

(54) ROBOT TOOL DEFORMATION AMOUNT CALCULATOR, ROBOT TOOL DEFORMATION AMOUNT CALCULATION SYSTEM, AND ROBOT TOOL DEFORMATION AMOUNT CALCULATION METHOD

(71) Applicant: FANUC CORPORATION, Yamanashi (JP)

(72) Inventor: Kyouhei KOKUBO, Yamanashi (JP)

(21) Appl. No.: 18/247,725

(22) PCT Filed: Sep. 29, 2021
(86) PCT No.: PCT/JP2021/035979

§ 371 Date: Oct. 30, 2023

(30) Foreign Application Priority Data
Oct. 6, 2020 (JP) 2020-169246

(51) Int. Cl. B25J 9/16

(52) U.S. Cl. CPC B25J 9/1638; B25J 9/1697

(57) ABSTRACT

A robot tool deformation amount calculator 300 includes an image acquisition unit 341 which acquires a first image in which a first measurement target 10 positioned at a tool attachment surface 122 of a tip of a robot 100 is captured and a second image in which a second measurement target 20 positioned on a tip 202 of the tool 200 is captured, a first measurement target position calculation unit 342 which calculates a position of the first measurement target 10 based on the first image, a second measurement target position calculation unit 343 which calculates a position of the second measurement target 20 based on the second image, and a tool deformation amount calculation unit 345 which calculates a deformation amount of the tool 2(X) in accordance with a posture of the robot 100 based on the position of the first measurement target 10 and the position of the second measurement target 20.

### DESCRIPTION

### FIELD

The present invention relates to a robot tool deformation amount calculator, a robot tool deformation amount calculation system, and a robot tool deformation amount calculation method.

### BACKGROUND

Conventionally, affixing a target to a tool attachment surface, capturing, with a camera, a mark on the target, and calculating the position of the focal point of the camera in a mechanical mechanical interface coordinate system Σf and the position of a predetermined point of the mark in a robot coordinate system Σb is known (for example, refer to Patent Literature 1).

### [CITATION LIST]

### [PATENT LITERATURE]

### [PTL 1] Japanese Patent No. 4267005

### SUMMARY

### [TECHNICAL PROBLEM]

Industrial robots consist of several rigid body parts and joint parts for rotating the rigid body parts. The rigid body parts and the joint parts elastically deform in accordance with the weight of the tool attached to the robot, the weight of the robot itself, or the posture of the robot. When calculating the position of the tool tip from the rotation angle values of the joints, if calculation is performed assuming that the rigid body parts and the joint parts do not deform, an error will occur in the calculation result due to elastic deformation. Thus, there is a technique to increase the accuracy of calculation by calculating the amount of elastic deformation of the robot and using the amount of elastic deformation to calculate the position of the tool tip of the robot.

Deformation such as elastic deformation occurs not only in robots but also in tools such as servo guns and hands attached to robots. Thus, in order to accurately determine the position of the tool tip, it is necessary to determine the degree of elastic deformation of the tool. Furthermore, since the degree of elastic deformation differs depending on the type of tool, it is necessary to obtain the degree of elastic deformation in accordance with the type of tool to be used. However, in order to obtain the degree of elastic deformation of the tool, an expensive three-dimensional measuring device such as a laser tracker is generally required, which causes problems such as complicated processes and high costs.

In the technique described in Patent Literature 1, when the target is imaged with the camera and the robot is calibrated, though errors in mechanical parameters such as link length and the origin position of each drive shaft are accurately and automatically determined and the mechanical parameters are corrected, since the target is affixed to the tool attachment surface, determination of the degree of elastic deformation of the tool is not assumed at all.

In one aspect, there is an object to provide a robot tool deformation amount calculator which can calculate the deformation amounts of various tools attached to a robot with a simple configuration, as well as a robot tool deformation amount calculation system and a robot tool deformation amount calculation method.

### [SOLUTION TO PROBLEM]

The spirit of the present disclosure is as described below.

One aspect of the present invention provides a robot tool deformation amount calculator comprising an image acquisition unit which acquires a first image in which a first measurement target positioned at a tool attachment part of a tip of a. robot is captured and a. second image in which a second measurement target positioned at a predetermined part more on a tip side of the tool than the tool attachment part is captured, a. first measurement target position calculation unit 30 which. calculates a position of the first measurement target based on the first image, a. second measurement target position calculation unit which calculates a position of the second measurement target based on the second image, and a tool deformation amount calculation unit which calculates a deformation amount of the tool in accordance with a posture of the robot based on the position of the first measurement target and the position of the second measurement target.

The first measurement target position calculation unit may calculate the position of the first measurement target based on the first image to calculate a position of a coordinate system of a camera which captures the first image and the second image, relative to the coordinate system of the robot.

The second measurement target position calculation unit may calculate the position of the second measurement target relative to a coordinate system of the robot from the position of the second measurement target relative to the coordinate system of the camera calculated based on the second image and a position of the coordinate system of the camera relative to the coordinate system of the robot, calculate a position and posture of the tool attachment part relative to the coordinate system of the robot based on angles of joints of the robot, and calculate the position of the second measurement target relative to the tool attachment part based on the position of the second measurement target relative to the coordinate system of the robot and the position and posture of the tool attachment part relative to the coordinate system of the robot.

There may further be provided an elastic deformation parameter determination unit which compares, in a plurality of postures of the robot, the position of the second measurement target relative to the tool attachment part calculated by the second measurement target position calculation unit and the position of the second measurement target relative to the tool attachment part obtained from a model formula representing elastic deformation of the tool to determine elastic deformation parameters of the tool included in the model formula, wherein the tool deformation amount calculation unit may calculate a deformation amount of the tool in accordance with the posture of the robot based on the model formula.

There may further be provided a tool position calculation unit which calculates the position of the predetermined part of the tool based on the deformation amount of the tool.

There may further be provided a robot deformation amount calculation unit which calculates a deformation amount of the robot in accordance with elastic deformation of the robot, wherein the tool position calculation unit may calculate the position of the predetermined part based on the deformation amount of the robot and the deformation amount of the tool.

The predetermined part may be the tip of the tool.

Another aspect of the present invention provides a robot tool deformation amount calculation system, comprising a first measurement target which is positioned at a tool attachment part of a. tip of a robot, a second measurement target which is positioned more on a tip side of the tool than the tool attachment part, a camera which is installed around the robot and which generates a first image in which the first measurement target is captured and a second image in which the second measurement target is captured, and a tool deformation amount calculator which calculates a deformation amount of the tool, wherein the tool deformation amount calculator comprises an image acquisition twit which acquires the first image and the second image, a first measurement target position calculation unit which calculates a position of the first measurement target based on the first image, a second measurement target position calculation twit which calculates a position of the second measurement target based on the second image, and a tool deformation amount calculation unit which calculates a deformation amount of the tool in accordance with a posture of the robot based on the position of the first measurement target and the position of the second measurement target.

Vet another aspect of the present invention provides a robot tool deformation amount calculation method, comprising the steps of acquiring a first image in which a first measurement target positioned on a. tool attachment part on a tip of a robot is captured and a second image in which a second measurement target positioned more on the tip side of the tool than the tool attachment part is captured, calculating a position of the first measurement target based on the first image, calculating a position of the second measurement target based on the second image, and calculating a deformation amount of the tool in accordance with a. posture of the robot based on the position of the first measurement target and the position of the second measurement target.

### [ADVANTAGEOUS EFFECTS OF INVENTION]

According to the present invention, the effect wherein there can be provided a robot tool deformation amount calculator which can calculate the deformation amounts of various tools attached to a robot with a simple configuration, as well as a robot tool deformation amount calculation system and a robot tool deformation amount calculation method is exhibited.

### BRIEF DESCRIPTION OF DRAWINGS

FIG. 1 is a schematic configuration view of a robot system in which a robot tool deformation amount calculator according to an embodiment is implemented.

FIG. 2 is a schematic view showing an aspect in which a tool is attached to the tool attachment surface on a tip of a robot.

FIG. 3 is a schematic configuration view of a. controller.

FIG. 4 is a functional block diagram of a processor, regarding processing in which tool deformation is calculated, and a tip position of a tool is calculated in consideration of the tool deformation.

FIG. 5 is a schematic view detailing various parameters of an elastic deformation model.

FIG. 6 is a schematic view detailing various parameters of an elastic deformation model,

FIG. 7 is a flowchart detailing processes of a robot tool deformation amount calculation method according to the present embodiment.

### DESCRIPTION OF EMBODIMENTS

Various embodiments according of the present invention will be described below while referring to the drawings. However, these descriptions are simply intended to illustrate preferable embodiments of the present invention and the present invention is not limited to such specific embodiments.

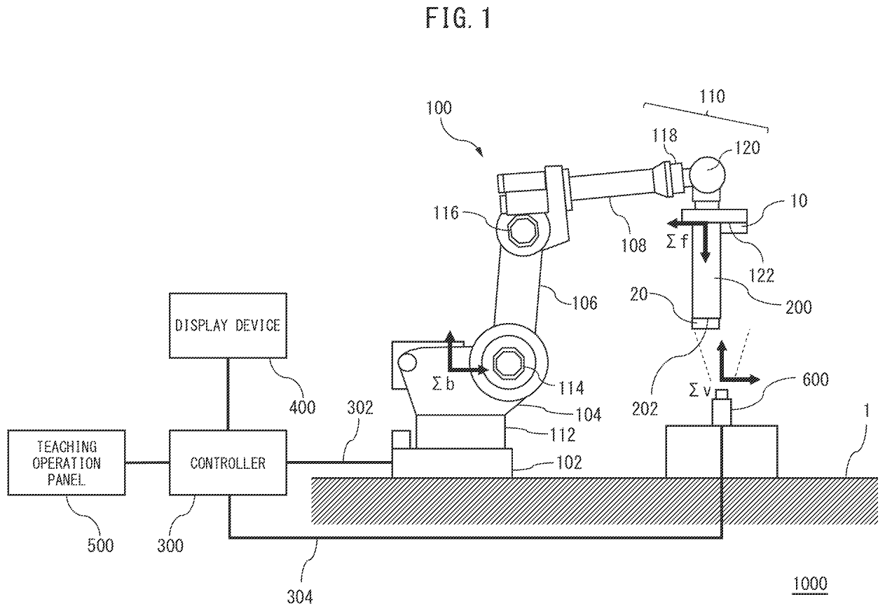

FIG. 1 is a schematic configuration view of a robot system 1000 in which the robot tool deformation amount calculator according to an embodiment is implemented. The robot system 1000 is one aspect of a robot tool deformation amount calculation system, and comprises a robot 100, a tool 200 attached to the tip of the robot 100, a controller 300 for controlling the robot 100 and the tool 200, a display device 400, a teaching operation panel 500, and a camera 600.

The robot 100 is, for example, an articulated robot, and comprises a pedestal 102, a rotating stage 104, a first arm 106, a second arm 108, and a wrist 110. The rotating stage 104, first arm 106, second arm 108, and wrist 110 are each supported by a shaft provided at the joint to which they are attached, and are operated by driving the shaft with a servomotor.

The pedestal 102 is a member which serves as a base when the robot 100 is installed on a floor 1. The rotating stage 104 is attached to the top surface of the pedestal 102 at joint 112 so as to be rotatable around an axis provided orthogonal to one surface of the pedestal 102.

The first arm 106 is attached at one end to the rotating stage 104 at joint 114 provided on the rotating stage 104. In the present embodiment, as shown in FIG. 1, the first arm 106 is rotatable at the joint 114 about an axis provided parallel to the surface of the pedestal 102 on which the rotating stage 104 is mounted.

The second arm 108 is attached at one end to the first arm 106 at joint 116 provided at the other end of the first arm 106 opposite to the joint 114. In this embodiment, as shown in FIG. 1, the second arm 108 is rotatable at the joint 116 about an axis provided parallel to the surface of the pedestal 102 on which the rotating stage 104 is mounted.

The wrist 110 is attached to the tip of second arm 108 opposite the joint 116 via joint 118. The wrist 110 has a joint 120 and can be bent at the joint 120 about an axis provided parallel to the axis of the joint 114 and the axis of the joint 116 as a center of rotation. Further, the wrist 110 may be rotatable at the joint 118 about an axis parallel to the longitudinal direction of the second arm 108 in a plane orthogonal to the longitudinal direction of the second arm 108.

The tool 200 is attached to a tool attachment surface (tool attachment part) 122 of the tip of the wrist 110 opposite the joint 118. The tool 200 has a mechanism or device for performing operations on the workpiece W. For example, the tool 200 may have a laser for processing the workpiece W, or may have a servo gun for welding the workpiece W. Alternatively, the tool 200 may have a hand mechanism for gripping the workpiece W or a component to be assembled with the workpiece W.

The controller 300 is one aspect of the robot tool deformation amount calculator. The controller 300 is connected to the robot 100 via a communication line 302, and receives information representing the operational status of the servo motors which drive the axes provided on each joint of the robot 100 from the robot 100 via the communication line 302. The controller 300 is also connected to the camera 600 via a communication line 304 and receives images captured and generated by the camera 600 from the camera 600 via the communication line 302, The controller 300 controls the servomotor based on received information and information received from a host controller (not shown) or set in advance representing operations of the robot 100 to control the position and posture of each movable part of the robot 100, and to control the tool 200 or camera 600.

The display device 400 is composed of, for example, a liquid crystal display device (LCD). The display device 400 displays images being captured by the camera 600., past images stored in a memory 330, images subjected to image processing, etc., as required, based on instructions from the controller 300.

Since the teaching operation panel 500 has a normal display function, through manual operation of the teaching operation panel 500, the operator can create, correct, and register an operation program for the robot 100, set various parameters, and reproduce taught operation program, jogs, etc. When the operator calculates the deformation amount of the tool 200, the operator can input a camera parameter representing information regarding the camera 600 to be used. A system program which supports the basic functions of the robot 100 and the controller 300 is stored in the ROM of the memory 330 of the controller 300, which will be described later. Furthermore, a robot operation program (for example, a spot-welding program) taught in accordance with the application and related setting data are stored in the non-volatile memory of the memory 330.

The camera 600 is installed on the floor 1 via a pedestal, a tripod, etc., and the position and posture thereof are not changed until the processing, according to the present embodiment is completed. The camera 600 has a two-dimensional detector composed of an array of photoelectric conversion elements sensitive to visible light, such as a CCD or CMOS, and has an image optical system which forms an image of the area to be photographed on the two-dimensional detector. The camera 600 is aimed in a direction in which the imaging range includes a first measurement target 10 attached to the tool attachment surface 122 or a second measurement target 20 attached to a tip 202 of the tool 200. The camera 600 captures the imaging range including the first measurement target 10 or the second measurement target 20 at each predetermined imaging cycle, thereby generating an image representing the first measurement target 10 or the second measurement target 20 in the imaging range. The camera 600 outputs the generated image to the controller 300 via the communication line 304 each time it generates an image.

As shown in FIG. 1, a coordinate system Σb affixed to the robot base (hereinafter referred to as the robot coordinate system), a coordinate system Σf affixed to time tool attachment surface 122 (hereinafter referred to as the tool attachment surface coordinate system), and a coordinate system Σv representing a line of sight from a representative point (for example, the center of the light-receiving surface) of the camera 600 toward a subject such as the first or second measurement targets 10, 20 (hereinafter referred to as a light-receiving device coordinate system) are set in the robot system 1000. Within the controller 300, the position and posture of the origin of the tool attachment surface coordinate system Σf can be known at any time based on specifications of the robot 100 such as the joint angle and arm length of the robot 100.

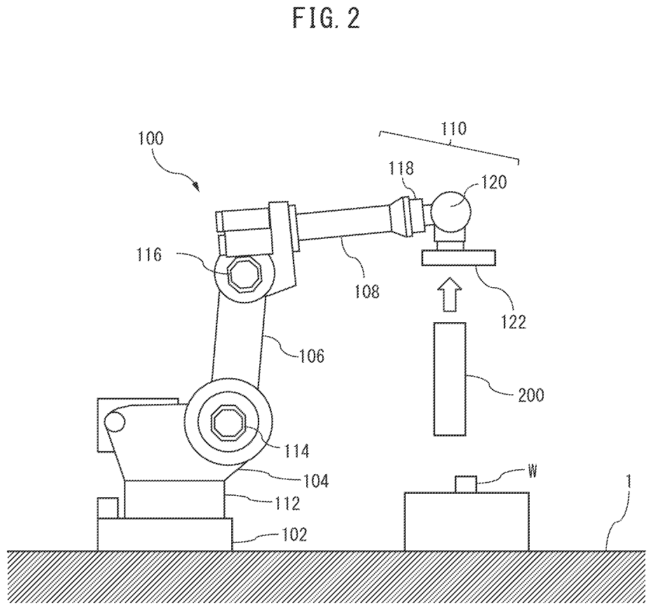

FIG. 2 is a schematic view showing an aspect in which the tool 200 is attached to the tool attachment surface 122 of the tip of the robot 100. Different tools 200 corresponding to various tasks are exchangeably attached to the tool attachment surface 122 in order to perform various tasks on the workpiece W on the floor 1.

The tools 200 attached to the robot 100 are deformed by elastically deformation etc. relative to the tool attachment surface 122 due to their own weight. In particular, when a relatively large and heavy tool 200, such as a servo gun for spot welding, is attached to the tool attachment surface 122, deformation of the tool 200 is relatively large. When performing operations on the workpiece W, the position of the tip 202 of the tool 200 (the position of the point of action on the workpiece W) is calculated, but in order to accurately calculate the position of the tip 202 of the tool 200, it is preferable to calculate the position of the tip 202 in consideration of the degree of deformation of the tool 200. Thus, the robot system 1000 according to the present embodiment can calculate a deformation amount for each of the various tools 200 attached to the tip of the robot 100.

The first measurement target 10 is attached to the tool attachment surface 122 at the tip of the robot 100 in order to calculate the deformation amount of the various tools 200. The second measurement target 20 is attached to a predetermined part on the tip side of the tool 200 relative to the tool attachment surface 122. In the following description, the case where the second measurement target 20 is attached to the tip 202 of the tool 200 will be described as an example, but the present embodiment is not limited to this, and the second measurement target 20 can he attached at any position on the tip side of the tool 200 relative to the tool attachment surface 122. The first measurement target 10 and the second measurement target 20 are, for example, plate-shaped, and include marks such as circles or crosses which serve as targets for detecting the first measurement target 10 or the second measurement target 20 from the image. Unless otherwise specified, “first measurement target 10” indicates such a mark. The same applies to the second measurement target 20.

When the user uses a specific tool 200, the first measurement target 10 and the second measurement target 20 may be manually installed by the user in order to calculate the deformation amount of the tool 200 or the position of the tip 202 of the tool 200 considering the deformation amount. Thus, the first measurement target 10 and the second measurement target 20 may be made of a sticker, paper, or the like having an adhesive layer. Conversely, the first measurement target and the second measurement target 20 may be attached to the tool attachment surface 122 or the tip 202 of each tool 200 in advance,

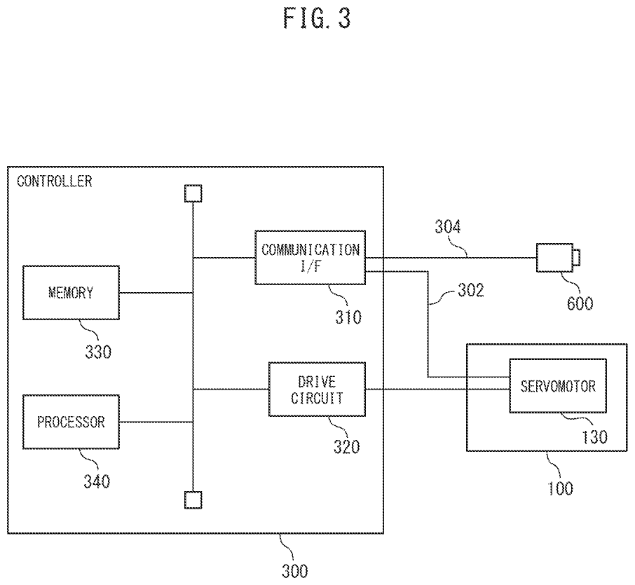

FIG. 3 is a schematic configuration view of the controller 300. The controller 300 comprises a communication interface 310, a drive circuit 320, memory 330, and a processor 340. The communication interface 310 comprises, for example, a communication interface for connecting the controller 300 to the communication line 302 or the communication line 304 and a circuit for executing processing related to transmission and reception of signals via the communication line 302 or the communication line 304. The communication interface 310 receives, for example, information representing the operational status of the servomotor 130, such as a rotation amount measurement value from an encoder for detecting the rotation amount of the servomotor 130, from the robot 100 via the communication line 302, and passes this information to the processor 340. Though one servomotor 130 is representatively shown in FIG. 3, the robot 100 may comprises a servomotor for driving the axis of each joint.

The communication interface 310 receives images generated and output by the camera 600 via the communication line 304 and passes them to the processor 340. Further, the communication interface 310 comprises an interface circuit for connecting, the processor 340 to the display device 400 or the teaching operation panel 500 and a circuit for executing processing related to transmission and reception of signals with the teaching operation panel 500 or the display device 400.

The drive circuit 320 is connected to the servomotor 130 via a cable for current supply, and supplies power to the servomotor 130 depending on the torque to generate in the servomotor 130, the direction of rotation, or the speed of rotation, in accordance with control by the processor 340.

The memory 330 has, for example, readable and writable semiconductor memory (RAM: Random Access Memory), read-only semiconductor memory (ROM: Read-Only Memory), non-volatile memory, etc. Further, the memory 330 may have a storage medium such as a semiconductor memory card, a hard disk, or an optical storage medium, and a device for accessing the storage medium.

The memory 330 stores various computer programs for controlling the robot 100 and the like, which are executed by the processor 340 of the controller 300. The memory 330 stores information for controlling the operation of the robot 100 when the robot 100 is operated. Further, the memory 330 stores information representing the operational status of the servomotor 130 obtained from the robot 100 while the robot 100 is operating. Furthermore, the memory 330 stores various data used in the deformation amount calculation processing of the tool 200. Such data includes camera parameters representing information regarding the camera 600, such as the focal length, mounting position, and orientation of the camera 600, images obtained from the camera 600, and information regarding specifications of the robot 100 such as the length of the first arm 106 or the second arm 108.

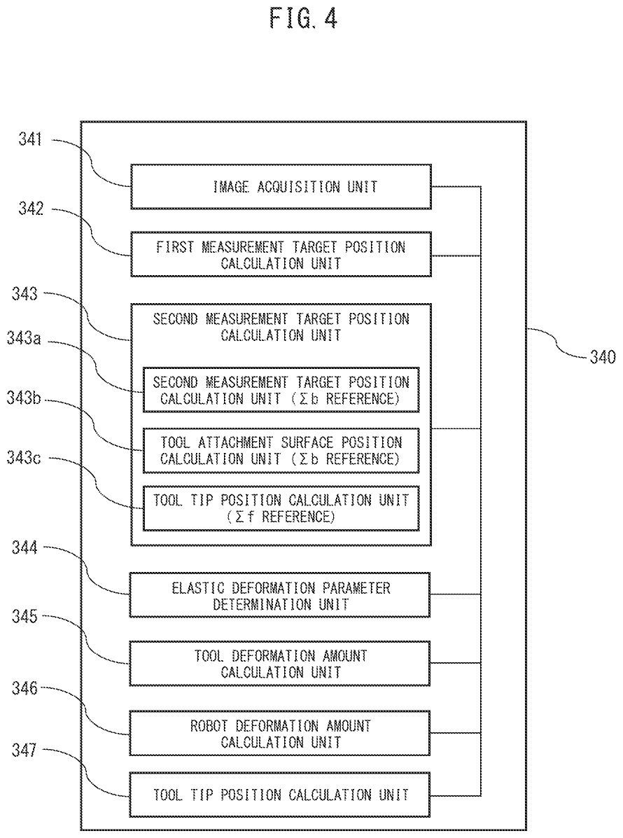

FIG. 4 is a functional block diagram of the processor 340 regarding processing for calculating the deformation of the tool 200 and calculating the tip position of the tool 200 in consideration of the deformation of the tool 200. The processor 340 acquires an image representing the first measurement target 10 and an image representing the second measurement target 20, calculates the position of the first measurement target from the image in which the first measurement target is represented, and calculates the position of the second measurement target 20 from the image in which the second measurement target 20 is represented.

When the position of the first measurement target 10 and the position of the second measurement target 20 are calculated, the deformation amount of the tool 200 can be calculated from the relative positions. At this time, if the deformation amount of the tool 200 is determined from the relative positions of the first measurement target 10 and the second measurement target in a plurality of postures of the robot 100, the deformation amount of the tool 200 in any posture of the robot 100 can be calculated.

More specifically, the processor 340 determines an elastic deformation parameter representing the degree of elastic deformation of the tool 200 from the deformation amount of the tool 200 calculated in a plurality of postures of the robot 100. When the elastic deformation parameters are determined, the deformation. amount of the tool 200 in any posture of the robot 100 can be calculated. If the deformation amount of the tool 200 in any posture of the robot 100 can be calculated, the tip position of the tool 200 can be determined with high accuracy in consideration of the deformation amount of the tool 200.

The processor 340 calculates the deformation amount due to elastic deformation of the robot 100, and calculates the tip position of the tool based on the deformation amount of the robot 100 and the deformation amount of the tool 200. As a. result. the tip position of the tool 200 can be determined with higher precision.

The processes performed by the processor 340 will be described in detail below As shown in FIG. 4, the processor 340 comprises an image acquisition unit 341, a first measurement target position calculation unit 342, a second measurement target position calculation unit 343, an elastic deft - lunation parameter determination unit 344, a tool deformation amount calculation unit 345. a.

robot deformation amount calculation unit 346, and a tool tip position calculation unit 347. Each of these units of the processor 340 is, for example, a functional module implemented. by a computer program executed by the processor 340. Alternatively, each of these units may be implemented as a dedicated arithmetic circuit implemented as part of processor 340.

The image acquisition unit 341 of the processor 340 acquires an image in which the first measurement target 10 is represented generated by the camera 600. The image acquisition unit 341 acquires an image in which the second measurement target 20 is represented generated by the camera 600.

The first measurement target position calculation unit 342 of the processor 340 performs image processing such as template matching on the image representing the first measurement target 10, or inputs the image into a machine-taught recognition device for target detection to detect the first measurement target 10. The first measurement target position calculation unit 342 calculates the position of the first measurement target 10 based on the image in which the first measurement target 10 is represented, and calculates the position and posture of the light-receiving device coordinate system Σv relative to the robot coordinate system Σb. Thus, the first measurement target position calculation unit 342 also functions as a. light-receiving device coordinate system calculation unit.

The first measurement target position calculation unit 342 calculates the position of the light-receiving device coordinate system Σv relative to the robot coordinate system Σb using, for example, the method described in Japanese Patent No. 419180. Since this method is well known, an overview will be given here. First, the robot 100 is translated, the first measurement target 10 in the image is aligned with the center point of the light-receiving surface (CCD array) of the camera 600, and the position Qf1 of the tool attachment surface coordinate system Σf in the robot coordinate system Σb is calculated. Next, after translating the robot 100 and moving the robot 100 to a position where the distance between the first measurement target 10 and the camera 600 is different, the first measurement target 10 in the image is aligned the center point of the light receiving surface, and the position Qf2 of the tool attachment surface coordinate system Σf in the robot coordinate system Σb is calculated. When the direction of the line of sight of the camera 600 connecting Qf1 and Qf2 is determined, after the robot 100 is moved to a position where Qf1 is rotated 180 degrees about an axis parallel to the direction of the line of sight and passing through the origin of the tool attachment surface coordinate system Σf, the robot 100 is translated, the first measurement target 10 in the image is aligned with the center point of the light receiving surface of the camera 600, and the position Qf3 of the tool attachment surface coordinate system Σf in the robot coordinate system Σb is calculated. As a result, the midpoint between Qf1 and Qf3 is determined as the origin position of the light-receiving device coordinate system Σv. By obtaining the line-of-sight direction of the camera 600 and the origin position of the camera 600, the position and posture of the light-receiving device coordinate system Σv relative to the robot coordinate system Σb can be determined. The positions of Qf1, Qf2, and Qf3 in the robot coordinate system Σb are calculated from specifications of the robot 100 such as the angles of the joints and the arm length of the robot 100. Though the position of the origin of the light-receiving device coordinate system Σv can be any position in the line of sight of the camera 600, it is preferably set to a position separated from the first measurement target by the focal distance of the camera 600 from the position where the size of the first measurement target 10 on the light receiving surface of the camera 600 matches the actual size of the first measurement target 10.

When the first measurement target 10 is attached to the tool 200, which may be deformed, the position of the first measurement target 10 is influenced by the elastic deformation of the tool 200, making it impossible to accurately determine the position and posture of the light-receiving device coordinate system Σv relative to the robot coordinate system Σb. In the present embodiment, by attaching the first measurement target 10 to the tool attachment surface 122, the position and posture of the light-receiving device coordinate system Σv relative to the robot coordinate system Σb can be determined with high accuracy.

The user can easily determine the position and posture of the fight-recti vine device coordinate system Σv relative to the robot coordinate system Σb simply by mounting the first measurement target 10 on the tool attachment surface 122 and installing an arbitrary camera 600 on the floor 1.

The second measurement target position calculation unit 343 of the processor 340 calculates the position of the second measurement target 20 attached to the tip 202 of the tool 200 relative to the tool attachment surface coordinate system Σf based on the image in which the second measurement target 20 is represented, to thereby calculate the position of the tip 202 of the tool 200. Since the second measurement target 20 represented in the image has positional deviation due to deformation of the tool 200, by calculating the position of the second measurement target 20 based on the image in which the second measurement target 20 is represented, the position of the tip 202 of the tool 200 including the influence of deformation of the tool 200 can be calculated.

In order to perform this process, the second measurement target position calculation unit 343 comprises a second measurement target position calculation unit 343a for calculating the position of the second measurement target 20 relative to the robot coordinate system Σb, a tool attachment surface position calculation unit 343b for calculating the position and posture of the tool attachment surface coordinate system Σf relative to the robot coordinate system Σb, and a tool tip position calculation unit 343c for calculating the position of the tip 202 of the tool 200 relative to the tool attachment surface coordinate system Σf.

The second measurement target position calculation unit 343a calculates the position of the second measurement target 20 relative to the light-receiving device coordinate system Σv using a known pinhole camera model as follows. First, by performing image processing such as template matching on the image in which the second measurement target 20 is represented or by inputting the image to a machine-taught recognition device for target detection, the second measurement target 20 represented in the image is detected. For the detected second measurement target 20, the position (Vt, Hz) in the image and the size Sz in the image of the second measurement target 20 are acquired. Note that the distance and size in the image can be measured, for example, by determining how many square “pixels” it occupies. At this time, the XY plane is set with the center of the image as the origin, and the coordinate values of the second measurement target 20 are set as position (Vt, Hz) in the image. The units of Vt, Hz, and Sz are mm.

The second measurement target position calculation unit 343a calculates, when the focal length of the camera 600 is defined as f (mm) and the actual size of the second measurement target 20 is defined as S0 the position (Xᵥ, Yᵥ, Zᵥ) of the second measurement target 20 relative to the light-receiving device coordinate system Σv from the following formulas (1) to (3). Note that the values of the focal length f and S0 are known.

Xᵥ=Vt×(S0/Sz) (1)

Yᵥ=Hz×(S0/Sz) (2)

Zᵥ=f×(S0/Sz) (3)

The position (Xᵥ, Yᵥ, Zᵥ) of the second measurement target 20 obtained here is the position relative to the light-receiving device coordinate system Σv. Conversely, the first measurement target position calculation unit 342 calculates the position and posture of the light-receiving device coordinate system Σv relative to the robot coordinate system Σb. Thus, the second measurement target position calculation unit 343a calculates the position (X_{b}, Y_{b}, Z_{b}) of the second measurement target 20 relative to the robot coordinate system Σb from the position (Xᵥ, Yᵥ, Zᵥ) of the second measurement target 20 relative to the light-receiving device coordinate system Σv and the position and posture of the light-receiving device coordinate system Σv relative to the robot coordinate system Σb. As a result, the position (Xᵥ, Yᵥ, Zᵥ) of the second measurement target 20 relative to the light-receiving device coordinate system Σv is coordinate-converted to the position (X_{b}, Y_{b}, Z_{b}) of the second measurement target 20 relative to the robot coordinate system) Σb.

The second measurement target position calculation unit 343a performs the processing described above on a plurality of images generated by the camera 600 while the posture of the robot 100 changes. As a result, the position (X_{b}, Y_{b}, Z_{b}) of the second measurement target 20 relative to the robot coordinate system Σb when the posture of the robot 100 is Pᵢ (i=1, 2, . . . , N (N is a natural number)) is calculated based on the image in which the second measurement target 20 is represented corresponding to a plurality of postures (P₁, P₂7, . . . , P_{N}).

The tool attachment surface position calculation unit 343b calculates the position and posture of the tool attachment surface coordinate system Σf relative to the robot coordinate system Σb, The tool attachment surface position calculation unit 343b calculates the position and posture of the tool attachment surface coordinate system Σf relative to the robot coordinate system Σb from specifications of the robot 100 such as the angle of each joint of the robot 100 and the lengths of the first arm 106 and the second arm 108. The angle of each joint of the robot 100 is obtained from an encoder for detecting the amount of rotation of the servomotor for driving the axis of each joint. Further, the specifications of the robot 100 such as the lengths of the first arm 106 and the second arm 108 are stored in the memory 330 in advance.

The tool tip position calculation unit 343c calculates the position of the tip 202 of the tool 200 relative to the tool attachment surface coordinate system Σf by calculating; the position of the second measurement target 20 relative to the tool attachment surface coordinate system Σf. The tool tip position calculation unit 343c calculates the position of the second measurement target 20 relative to the tool attachment surface coordinate system Σf when the posture of the robot is Pi (i=1, 2, . . . , N), i.e., the position (X_{f}, Y_{f}, Z_{f}) of the tip 202 of the tool 200 based on the position (X_{b}, Y_{b}, Z_{b}) of the second measurement target 20 relative to the robot coordinate system Σb calculated by the second measurement target position calculation unit 343a and the position and posture of the tool attachment surface coordinate system Σf relative to the robot coordinate system Σb calculated by the tool attachment surface position calculation unit 343b. As a result, the position (X_{b}, Y_{b}, Z_{b}) of the second measurement target 20 relative to the robot coordinate system Σb is coordinate-transformed into the position (X_{f}, Y_{f}, Z_{f}) of the tip 202 of the tool 200 relative to the tool attachment surface coordinate system Σf.

Since the position (X_{f}, Y_{f}, Z_{f}) of the tip 202 of the tool 200 relative to the tool attachment surface coordinate system Σf calculated as described above is calculated based on the image of the second measurement target 20 captured by the camera 600, it includes factors of the elastic deformation of the tool 200, depending on the posture of the robot 100. Thus, the position (X_{f}, Y_{f}, Z_{f}) of the tip 202 of the tool 200 including the influence of the elastic deformation of the tool 200 is calculated for each case where the posture of the robot is Pi (i=1, 2, . . . , N). Note that the position

(X_{f}, Y_{f}, Z_{f}) of the tip 202 of the tool 200 relative to the tool attachment surface coordinate system Σf is the same value for any of N postures Pi (i=1, 2, . . . , N) when the tool 200 does not deform. However, when the tool 200 deforms, the position (X_{f}, Y_{f}, Z_{f}) of the tip 202 of the tool 200 relative to the tool attachment surface coordinate system Σf will differ depending on the posture of the tool 200.

The elastic deformation parameter determination unit 344 of the processor 340 determines the elastic deformation parameter of the tool 200 based on the position (X_{f}, Y_{f}, Z_{f}) of the tip 202 of the tool 200 relative to the tool attachment surface coordinate system Σf, including the effect of elastic deformation of the tool 200., calculated by the second measurement target position calculation unit 343. Specifically, the elastic deformation parameter determination unit 344 determines the value of the elastic deformation parameter a, which represents the degree of elastic deformation of the tool 200, using the elastic deformation model represented by the following formulas (4) to (6).

Xₘ=α×sin θ×cos φ (4)

Yₘ=α×sin θ×cos φ (5)

Zₘ=Z₀ (6)

In formulas (4) to (6), Xₘ, Yₘ, Zₘ represent the position (coordinate values) of the tip 202 of the tool 200 relative to the tool attachment surface coordinate system Σf of the robot 100 in the elastic deformation model, and correspond to the position (X_{f}, Y_{f}, Z_{f}) of the tip 202 of the tool 200 relative to the tool attachment surface coordinate system Σf calculated by the tool tip position calculation unit 343c, The unit of (Xₘ, Yₘ, Zₘ) and (X_{f}, Y_{f}, Z_{f}) is mm.

In formulas (4) and (5), the elastic deformation parameter a representing the degree of elastic deformation of the tool 200 becomes larger as the tool 200 is more likely to bend. If the tool 200 does not bend, the value of the elastic deformation parameter α is 0.

In formulas (4) and (5), θ represents the angle at which the tool 200 is inclined from the reference posture relative to the direction of gravity (the Z-axis direction of the robot coordinate system Σb). The unit of θ is degrees (deg), and 0≤θ≤90. Furthermore, in formulas (4) and (5), φ is the angle at which the tool 200 is inclined, and represents the inclination as viewed from the tool attachment surface coordinate system Σf. The unit of φ is also degrees (deg), and 0≤φ≤90.

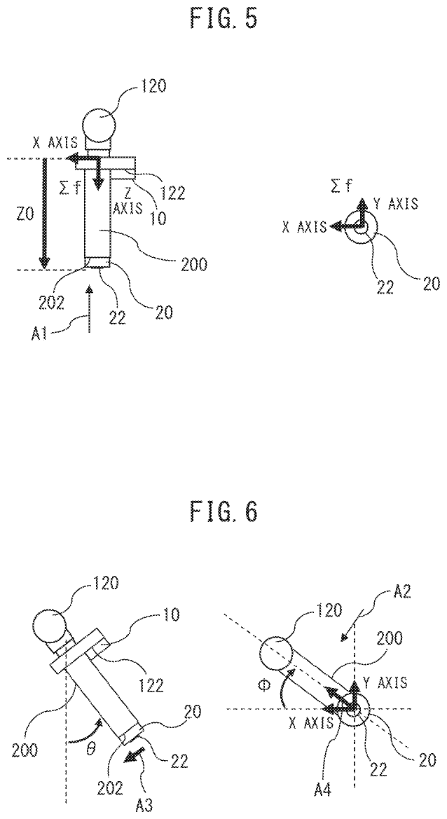

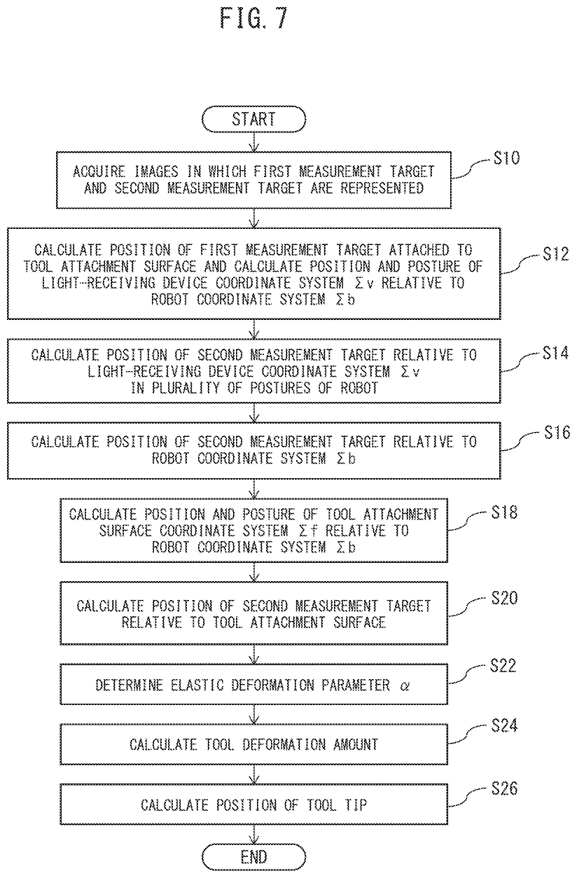

FIGS. 5 and 6 are schematic views detailing each parameter of formulas (4) to (6). FIG. 5 shows a baseline posture in which the tool 200 is not inclined. In FIGS. 5 and 6, it is assumed that the tool 200 has a cylindrical shape, and in the standard posture, the axis of the cylinder of the tool 200 coincides with the direction of gravity. FIGS. 5 and 6 also show a mark 22 drawn on the second measurement target 20 attached to the tip 202 of the tool 200. The diagram shown on the left side of FIG. 5 illustrates the state of the tool 200 as viewed from the side (horizontal direction). The diagram shown on the right side of FIG. 5 illustrates the tool 200 as viewed from below (from the direction of arrow A1 in the left-side diagram). In the reference position shown in FIG. 5, the position of the tip 202 of the tool 200 is X_{f}=0, Y_{f}=0, Z_{f}=Z₀) relative to the tool attachment surface coordinate system Σf.

FIG. 6 shows the posture when the tool 200 is inclined from the state of FIG. 5 by an angle 0 relative to the direction of gravity. The diagram on the right side of FIG. 6 illustrates the state of the tool 200 as viewed from below, in the same manner as the diagram on the right side of FIG. 5. The coordinate axes shown in the diagram on the right side of FIG. 6 schematically illustrate how the coordinate axes (X-axis. Y-axis) of the tool attachment surface coordinate system Σf in the standard posture shown in FIG. 5 are inclined, and illustrates a state in which the tool 200 is inclined by an angle φ relative to the X-axis of the tool attachment surface coordinate system Σf. Furthermore, the diagram on the left side of FIG. 6 shows the state in which the diagram on the right side of FIG. Cis viewed from the side (direction of arrow A2), and illustrates a state in which the tool 200 is inclined by an angle 0 relative to the reference posture.

As shown in FIG. 6, when the tool 200 is inclined by an angle θ relative to the direction of gravity, the weight of the tool 200 deforms the tip 202 of the tool 200 in the directions indicated by arrows A3 and A4 in FIG. 6.

The elastic deformation parameter determination unit 344 calculates values of θ and φ from the posture of the robot 100 for each of N postures Pi (i=1, 2, . . . , N) of the robot 100. The values of θ and φ are calculated by determining the angle of each joint from the encoder value for detecting the rotation amount of the servomotor driving the axis of each joint, and determining the position and posture of the tool attachment surface 122 (tool attachment surface coordinate system Σf) of the robot 100 from the angle of each joint and the specifications of the robot 100.

The elastic deformation parameter determination unit 344 determines the value of the elastic deformation parameter a for each of the N postures Pi (i=1, 2, . . . , N) of the robot 100 using the least squares method or the like in order to minimize the difference between the position (X_{f}, Y_{f}, Z_{f}) of the tip 202 of the tool 200 relative to the tool attachment surface coordinate system Σf actually calculated by the tool tip position calculation unit 343c and the model values (Xₘ, Yₘ, Zₘ) calculated from the model of formulas (4) to (6).

121,

When the elastic deformation parameter a representing the degree of elastic deformation of the tool 200 is determined as described above, based on the values of θ and φ determined in accordance with the elastic deformation parameter a and the posture of the robot 100, the coordinates Xₘ, Yₘ, Zₘ of the tip 202 of the tool 200, i.e., the deformation amount of the tool 200, are determined from the elastic deformation model of formulas (4) to (6). The tool deformation amount calculation unit 345 of the processor 340 calculates the position Xₘ, Yₘ, Zₘ of the tip 202 of the tool 200 relative to the tool attachment surface coordinate system Σf as the deformation amount of the tool 200 in any posture of the robot 100 based on the elastic deformation model of formulas (4) to (6).

The deformation amount of the tool 200 determined as described above can be determined by mounting the first measurement target 10 and the second measurement target 20 and setting the camera 600 on the floor 1 when the user uses the specific tool 200. Conversely, the deformation amount of the tool 200 may be calculated in advance and stored in the memory 330 or the like when the robot system 100 or the tool 200 is shipped.

The robot deformation amount calculation unit 346 of the processor 340 calculates the elastic deformation amount of the robot 100 relative to the theoretical position and posture of the tool attachment surface 122 based on the robot coordinate system Σb. As described above, the rigid body parts and joint parts of the robot 100 are elastically deformed depending on the posture of the robot 100 due to the weight of the tool 200 attached to the robot 100 and the weight of the robot 100 itself. The robot deformation amount calculation unit 346 calculates the elastic deformation amount of the robot 100 corresponding to the posture of the robot 100 using, for example, the method of calculating the torque of each joint and calculating the deflection amount of each joint from the spring constant of each joint and the torque of each joint described in Japanese Unexamined Patent Publication (Kokai) No. 2002-307344. Note that even when the tool attachment surface position calculation unit 343b calculates the position and posture of the tool attachment surface coordinate system Σf relative to the robot coordinate system Σb, the position and posture of the tool attachment surface coordinate system Σf relative to the robot coordinate system Σb may be calculated in consideration of the deformation amount of the robot 100 calculated by the robot delimitation amount calculation unit 346.

The tool tip position calculation unit 347 of the processor 340 calculates the position of the tip 202 of the tool 200 in consideration of the deformation amount of the tool 200 based on the position Xₘ, Yₘ, Zₘ of the tip 202 of the tool 200 relative to the tool attachment surface coordinate system Σf calculated by the tool deformation amount calculation unit 345 based on the elastic deformation model and the position of the tool attachment surface coordinate system Σf relative to the robot coordinate system Σb determined from the angle of each joint of the robot 100 and the specifications of the robot 100. Further, the tool tip position calculation unit 347 can also calculate the position of the tip 202 of the tool 200 in consideration of the deformation amount of the tool 200 and the deformation amount of the robot 100 based on the position Xₘ, Yₘ, Zₘ of the tip 202 of the tool 200 relative to the tool attachment surface coordinate system Σf calculated by the tool deformation amount calculation unit 345 based on the elastic deformation model, the position of the tool attachment surface coordinate system Σf relative to the robot coordinate system Σb determined from the angle of each joint of the robot 100 and the specification of the robot 100, and the deformation amount of the robot 100 based on the robot coordinate system Σb calculated by the robot deformation amount calculation unit 346.

As a result, since the position of the tip . 202 of the tool 200 is calculated in consideration of the deformation amount of the tool 200, when performing operations on the workpiece W, it is possible to align the tip 202 of the tool 200 with the workpiece W with high accuracy. Furthermore, since the position of the tip 202 of the tool 200 is calculated in consideration of the elastic deformation of the robot 100, the tip 202 of the tool 200 can be aligned with the workpiece W with higher accuracy.

Next, processing of the robot tool deformation amount calculation method according to the present embodiment will be described based on the flowchart of FIG, 7. First, the first measurement target 10 is attached to the tool attachment surface 122, the second measurement target 20 is attached to the tip 202 of the tool 200, and in a state in which the camera 600 is installed on the floor 1, the image acquisition unit 341 of the processor 340 of the controller 300 acquires images in which the first measurement target 10 and the second measurement target 20 are represented (step S10). Next, the first measurement target position calculation unit 342 of the processor 340 calculates the position of the first measurement target 10 attached to the tool attachment surface 122, and calculates the position and posture of the light-receiving device coordinate system Σv relative to the robot coordinate system Σb (step S12).

Next, the second measurement target position calculation unit 343a of the processor 340 calculates the position of the second measurement target 20 relative to the light receiving device coordinate system Σv in a plurality of postures of the robot 100 (step S14), and calculates the position of the second measurement target 20 relative to the robot coordinate system Σb (step S16).

Next, the tool attachment surface position calculation unit 343b of the processor 340 calculates the position and posture of the tool attachment surface coordinate system Σf relative to the robot coordinate system Σb (step S18). Next, the tool tip position calculation unit 343c of the processor 340 calculates the position of the second measurement target 20 relative to the tool attachment surface 122, i.e., the position of the tip 202 of the tool 200 (step S20).

Next, the elastic deformation parameter determination unit 344 of the processor 340 determines the elastic deformation parameter α in the elastic deformation model (step S22). Next, the tool deformation amount calculation unit 345 of the processor 340 calculates the position (Xₘ, Yₘ, Zₘ) of the tip of the tool 200 relative to the tool attachment surface coordinate system Σf, i.e., the deformation amount of the tool 200, based on the elastic deformation model (step 524). Next, the tool tip position calculation unit 347 of the processor 340 calculates the position of the tip 202 of the tool 200 relative to the robot coordinate system Σb in consideration of the deformation amount of the tool 200 (step S26).

According to the present embodiment as described above, since the position of the second measurement target 20 attached to the tip 202 of the tool 200 is determined from the image captured by the camera 600 in a plurality of postures of the robot 100, and the elastic deformation parameters of the elastic deformation model are calculated, the elastic deformation amounts of various tools 200 attached to the tip of the robot 100 can accurately be calculated with a simple configuration.

Furthermore, since the user using the robot system 1000 attaches the first measurement target and the second measurement target 20 themselves and installs an arbitrary camera 600, the elastic deformation amounts of various tools 200 intended to be used by the user can accurately be calculated without complicated operations and without using an expensive three-dimensional measuring device.

All examples and specific terminology used herein are intended for instructional purposes to assist the reader in understanding the concepts contributed by the inventors to the advancement of the present invention and the prior art, and are not to be construed as limiting any exemplary configuration, such specific examples and conditions mentioned in the specification, to show superiority or inferiority of the present invention. Though the embodiments of the invention have been described in detail, it should be understood that various changes, substitutions, and modifications can be made without departing from the spirit and scope of the invention.

### REFERENCE SIGNS LIST

1 floor
41 first measurement target
20 second measurement target
22 mark
100 robots
102 pedestal
104 rotating stage
106 first arm
108 second arm
110 wrist
112 114, 116. 118, 120 joint
122 tool attachment surface
130 servo motor
200 tool
202 tip
300 controller
302, 304 communication line
310 communication interface
320 drive circuit
330 memory
340 processor
341 image acquisition unit
342 first measurement target position calculation unit
343 second measurement target position calculation unit
343a second measurement target position calculation unit
343b tool attachment surface position calculation unit
343c tool tip position calculation unit
344 elastic deformation parameter determination unit
345 tool deformation amount calculation unit
346 robot deformation amount calculation unit
347 tool tip position calculation unit
400 display device
500 teaching operation panel
600 camera
1000 robot system

1. A robot tool deformation amount calculator, comprising:
a processor configured to:
acquires a first image in which a first measurement target positioned at a tool attachment part of a tip of a robot is captured and a second image in which a second measurement target positioned at a predetermined part more on a tip side of the tool than the tool attachment part is captured,
calculate a position of the first measurement target based on the first image,
calculate a position of the second measurement target based on the second image, and
calculate a deformation amount of the tool in accordance with a posture of the robot based on the position of the first measurement target and the position of the second measurement target.

2. The robot tool deformation amount calculator according to claim 1, wherein the processor is configured to calculate the position of the first measurement target based on the first image to calculate a position of a coordinate system of a camera which captures the first image and the second image, relative to a coordinate system of the robot.

3. The robot tool deformation amount calculator according to claim 2, wherein the processor is configured to calculate the position of the second measurement target relative to a coordinate system of the robot from the position of the second measurement target relative to the coordinate system of the camera calculated based on the second image and a position of the coordinate system of the camera relative to the coordinate system of the robot, calculate a position and posture of the tool attachment part relative to the coordinate system of the robot based on angles of joints of the robot, and calculate the position of the second measurement target relative to the tool attachment part based on the position of the second measurement target relative to the coordinate system of the robot and the position and posture of the tool attachment part relative to the coordinate system of the robot.

4. The robot tool deformation amount calculator according to claim 3, wherein the processor is configured to:
compares, in a plurality of postures of the robot, the position of the second measurement target relative to the tool attachment part calculated by the second measurement target position calculation unit and the position of the second measurement target relative to the tool attachment part obtained from a model formula representing elastic deformation of the tool to determine elastic deformation parameters of the tool included in the model formula, and
calculate a deformation amount of the tool in accordance with the posture of the robot based on the model formula.

5. The robot tool deformation amount calculator according claim 1, wherein the processor is further configured to calculate the position of the predetermined part of the tool based on the deformation amount of the tool.

6. The robot tool deformation amount calculator according to claim 5, wherein the processor is further configured to:
calculate a deformation amount of the robot in accordance with elastic deformation of the robot, and
calculate the position of the predetermined part based on the deformation amount of the robot and the deformation amount of the tool.

7. The robot tool deformation amount calculator according to claim 1, wherein the predetermined part is a tip of the tool.

8. A robot tool deformation amount calculation system, comprising:
a first measurement target which is positioned at a tool attachment part of a tip of a robot,
a second measurement target which is positioned more on a tip side of the tool than the tool attachment part,
a camera which is installed around the robot and which generates a first image in which the first measurement target is captured and a second image in which the second measurement target is captured, and
a tool deformation amount calculator which calculate a deformation amount of the tool, wherein
the tool deformation amount calculator comprises:
a processor configured to:
the first image and the second image,
calculate a position of the first measurement target based on the first image,
calculate a position of the second measurement target based on the second image, and
calculate deformation amount of the tool in accordance with a posture of the robot based on the position of the first measurement target and the position of the second measurement target.

9. A robot tool deformation amount calculation method, comprising the steps of:
acquiring a first image in which a first measurement target positioned on a tool attachment part on a tip of a robot is captured and a second image in which a second measurement target positioned more on the tip side of the tool than the tool attachment part is captured,
calculating a position of the first measurement target based on the first image,
calculating a position of the second measurement target based on the second image, and
calculating a deformation amount of the tool in accordance with a posture of the robot based on the position of the first measurement target and the position of the second measurement target.
